(19) United States
(12) Patent Application Publication
(10) Pub. No.: US 2019/0048793 A1
(43) Pub. Date: Feb. 14, 2019

(54) SYSTEM FOR STORING AND DELIVERING AN AUXILIARY LIQUID TO AN INTERNAL COMBUSTION ENGINE OF A MOTOR VEHICLE OR TO PARTS OF THE INTERNAL COMBUSTION ENGINE OF THE MOTOR VEHICLE

(71) Applicant: KAUTEX TEXTRON GMBH & CO. KG, Bonn (DE)

(72) Inventors: Timm HEIDEMEYER, Koeln (DE); Hartmut WOLF, Koenigswinter (DE)

(21) Appl. No.: 16/076,901

(22) PCT Filed: Aug. 2, 2016
(86) PCT No.: PCT/EP2016/068468

§ 371 Date: Aug. 9, 2018

(30) Foreign Application Priority Data
Feb. 9, 2016 (DE) 10 2016 201 944.9

(51) Int. Cl. F02B 47/02; F02B 41/00; F02B 39/00

(52) U.S. Cl. CPC F02B 47/02; F02B 39/00; F02B 41/00

(57) ABSTRACT

The invention relates to a system and to a method for operating a system for storing and supplying an auxiliary liquid to an internal combustion engine of a motor vehicle or to parts of the internal combustion engine of the motor vehicle, in particular a water-injection system for the internal combustion engine of a motor vehicle, comprising a reservoir for the fluid, comprising at least one conveying pump for the fluid, and comprising at least one line system, which has a feed flow to a consumer and a return flow into the reservoir, and comprising means for heating the fluid.

### FIELD

The invention relates to a system for storing and supplying an auxiliary liquid to an internal combustion engine of a motor vehicle or to parts of the internal combustion engine of the motor vehicle. The invention further relates to a method for operating a system for storing and supplying an auxiliary liquid to an internal combustion engine of a motor vehicle or to parts of the internal combustion engine of the motor vehicle.

The invention relates in particular to a water-injection system for the internal combustion engine of a motor vehicle.

### BACKGROUND

In the case of water-injection systems for motor vehicles, not only the reservoir but also valves and lines can freeze. Ice can lead to damage inside the reservoir or inside the lines as a result of expansion and can considerably prolong the time until the system is ready for use.

A system as previously described must therefore be usable within the shortest possible time after the start-up of the internal combustion engine.

### SUMMARY

The problem addressed by the invention is therefore that of providing a system which meets these requirements.

According to one aspect of the invention, a system is provided, comprising a reservoir for the fluid, comprising at least one conveying pump for the fluid and comprising at least one line system, which has a feed flow to a consumer and a return flow into the reservoir, means for heating the fluid being provided.

The reservoir can be in the form of a water reservoir. Alternatively, however, the reservoir can also be in the form of a reservoir for an aqueous urea solution which is provided for exhaust gas treatment on an internal combustion engine.

The system can comprise one or more consumers in the form of distribution nozzles which inject the auxiliary liquid, for example water, into the intake system of an internal combustion engine, into the combustion chamber of an internal combustion engine or into the exhaust gas system of an internal combustion engine.

According to one aspect of the present invention, the problem mentioned at the outset is solved in that the system comprises means for heating the return volume flow of the fluid.

As means for heating the fluid, at least one electrical heating device and/or one heat exchanger can be provided.

Preferably, the electrical heating device and/or the heat exchanger are arranged in the return flow.

In one advantageous variant of the system, it is provided that the heat exchanger is thermally coupled to a primary cooling circuit of the internal combustion engine.

Conventionally, the return volume flow of a water-injection system is approximately 30 l/h. Said return volume flow, which is fed back from an injection system on the internal combustion engine for example at a pressure of approximately 7 bar, already contains a significant amount of thermal energy, which is used according to the invention to defrost the reservoir, said return volume flow preferably being heated using the heat of the internal combustion engine.

Of course, alternative or additional electric heating of the return volume flow is also within the scope of the invention.

Heat can be extracted from the primary cooling circuit of the internal combustion engine for example by means of at least one heat exchanger which can take or extract the heat from the immediate surroundings of the internal combustion engine.

Preferably, the return volume flow of the fluid is heated to a temperature of approximately 60° C. The thermal energy of the return volume flow at 60° C. is approximately 2.1 kW.

Expediently, the extraction of heat from the internal combustion is interrupted if the temperature of the return volume flow exceeds 60° C.

If heat is extracted from the primary cooling circuit of the internal combustion engine by means of a heat exchanger, a bypass line comprising a bypass switch can be provided in the heat exchanger circuit, the bypass switch being able to comprise a valve assembly which can be switched according to the temperature to divert the heat exchanger medium.

The pressure in the return flow to the reservoir can be between 5 and 7 bar. By means of a flow restrictor comprising a suitable distribution nozzle, the warm return volume flow can be depressurized to atmospheric pressure in the reservoir and distributed in the reservoir at an elevated speed.

An electric heater for heating part of the fluid volume in a start-up phase of the internal combustion engine can additionally be provided. An electric heater of this type can be switched off after the operating temperature of the return flow is reached.

The system according to the invention can comprise a control unit by means of which the conveying pump and at least one electrically switchable valve can be controlled. Furthermore, the system can be operable in a test mode, by which it is determined, by means of a conveyed volume flow to be detected, whether the line system is free of ice. If it is detected that the system, for example the lines, is/are iced up, at least one electrical heating device and/or a switchable valve which can be operated electrically or mechanically can be activated by means of the control unit.

According to another aspect of the invention, the system comprises a connection module which is inserted in an opening of the reservoir, the connection module comprising fluid channels which communicate with the reservoir and which are connected to the feed feed flow line and the return feed flow line of the line system, and the connection module having a module block which is preferably in the form of a thermally conductive member.

The connection module can comprise valves for ventilating the system and for draining the system.

The connection module can further comprise at least one thermally conductive member or heating member, for example having an enlarged surface, which extends into the volume of the reservoir.

In a preferred variant of the system, it is provided that the return flow is connected to at least one distribution nozzle inside the reservoir, by means of which nozzle the fluid from the return flow is distributed in the reservoir. The fluid can be depressurized for example from a first, higher pressure of approximately 7 bar to a second, lower pressure of approximately 1 bar by means of the distribution nozzle.

In a further preferred variant of the system according to the invention, it is provided that an impeller is arranged in front of the distribution nozzle, which impeller is rotatably mounted and can be impinged upon by the fluid, and which impeller can be driven by means of the fluid issuing from the distribution nozzle. The impeller can be provided for example with at least two rotor blades, on which the fluid issuing from the distribution nozzle impinges. The rotor blades can be in the form of a hydraulically effective profile so that the fluid coming into contact with the rotor blades sets the impeller into rotation. In this manner, a particularly advantageous distribution of the fluid issuing from the distribution nozzle is achieved.

A person skilled in the art can see that a plurality of distribution nozzles can be provided. These can be arranged for example on the same nozzle assembly.

In another preferred variant of the system according to the invention, it is provided that an impact body is arranged in front of the distribution nozzle, which body brings about a further distribution of the fluid.

The impact body can be for example in the form of a cone or prism, a point of the cone or prism preferably being oriented toward an outlet opening of the distribution nozzle. By means of lateral faces of the impact body, the fluid is distributed and atomized over a large surface area.

In another preferred variant of the system according to the invention, a rotatably arranged nozzle assembly is provided, which comprises two distribution nozzles which are oriented relative to one another in such a way that the potential energy of the fluid issuing from the distribution nozzles is converted into a torque which sets the nozzle assembly into rotation. Preferably, the outlet openings of the distribution nozzles are oriented so as to be diametrically opposed to one another. The nozzle assembly, as a reaction water wheel, uses the potential energy of the water jet.

The problem addressed by the invention is further solved by a method for operating a system for storing and supplying an auxiliary liquid to an internal combustion engine of a motor vehicle or to parts of the internal combustion engine of the motor vehicle, preferably using a system of the above-described type, comprising a reservoir for the fluid, comprising at least one conveying pump for the fluid and comprising at least one line system, which has a feed flow to a consumer and a return flow into the reservoir, wherein heat is coupled into the fluid by means of an electrical heating device and/or by means of a heat exchanger.

Preferably, the heat coupled into the fluid is extracted from a primary cooling circuit of the internal combustion engine.

The return volume flow can be heated for example to a temperature of at most 60° C. Preferably, the temperature of the return volume flow is controlled by means of a suitable control unit according to the actual temperature of the return volume flow.

In the case of the method according to the invention, inside the reservoir, the return flow of the fluid is depressurized from a first, high pressure, of for example approximately 5 to 7 bar, to a second, lower pressure, of for example approximately 1 bar, preferably using at least one distribution nozzle.

### BRIEF DESCRIPTION OF THE DRAWINGS

The invention will be described below with reference to an embodiment shown in the drawings, in which:

FIG. 1 is a schematic view of a system according to the invention;

FIG. 1a is an enlarged view of a detail from FIG. 1;

FIG. 2 is a calculation example which shows the heating power required to defrost a volume of ice of approximately 7 l;

FIG. 3 is a mathematical representation of the defrosting power of the return volume flow at a return flow temperature of 60° C. and at a return flow temperature of 20° C.;

FIG. 4a is a view of an arrangement of distribution nozzles with an impeller arranged in front thereof;

FIG. 4b is a plan view of the impeller shown in FIG. 4a;

FIG. 5a is a plan view of a rotatable nozzle assembly which is in the form of a reaction water wheel;

FIG. 5b is a side view of the nozzle assembly shown in FIG. 5a; and

FIG. 6 is a side view of a distribution nozzle with an impact body arranged in front thereof (conical distributor).

### DETAILED DESCRIPTION

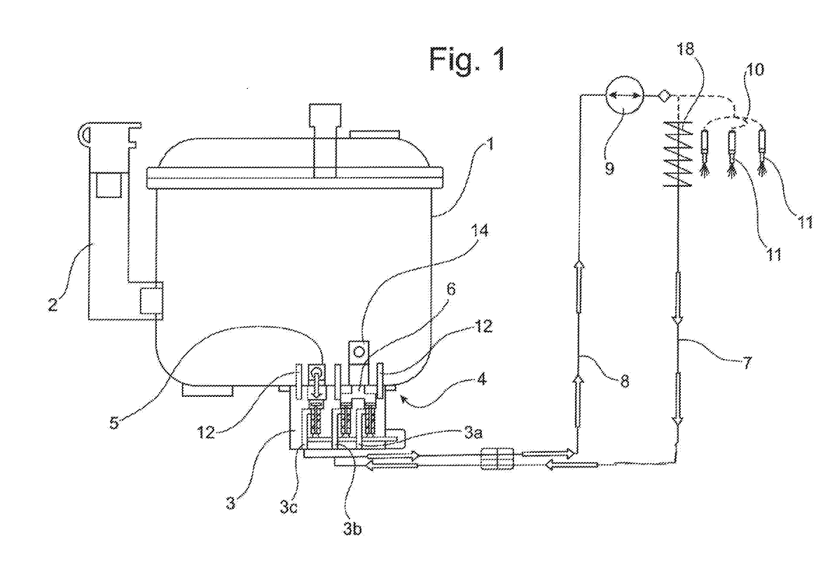

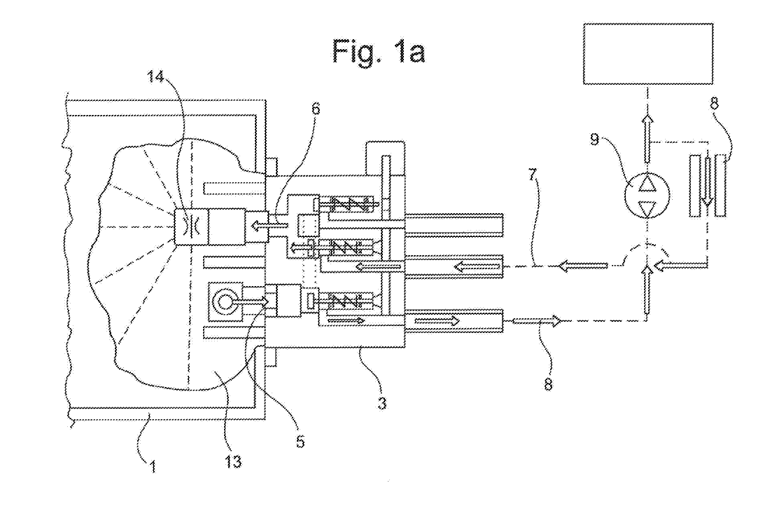

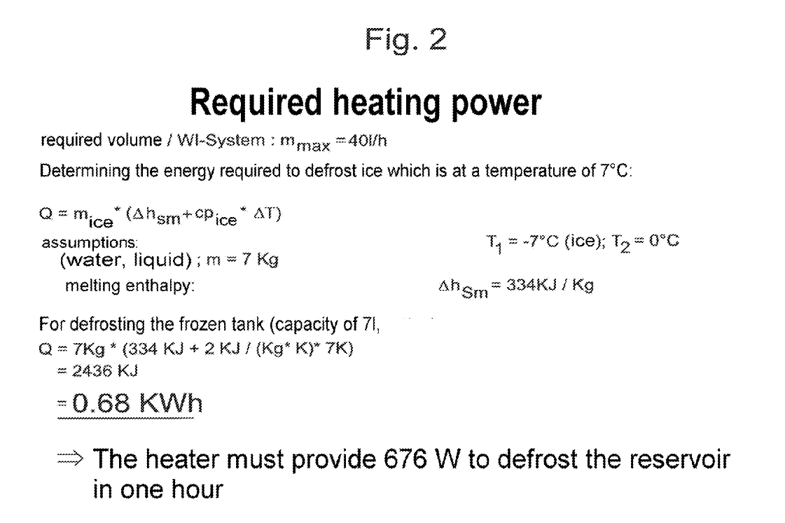

The system shown schematically in FIG. 1 comprises a reservoir 1 having a filling pipe 2 and having means for ventilating the reservoir 1 and having means (not shown) for detecting the fill level.

The reservoir 1 comprises a flush-mounted connection module 3 which is inserted in an opening 4 in the base of the reservoir 1. The connection module can be inserted both in the base of the reservoir 1 and in a side wall of the reservoir 1. If the connection module 3 is inserted in a side wall of the reservoir 1, said module is preferably inserted in the reservoir in the bottom third or quarter of the side wall which is adjacent to the base of the reservoir. It will be understood by a person skilled in the art that the connection module 1 should be connected to the reservoir 1 as low down as possible with respect to a minimum possible liquid level inside the reservoir 1. The connection module 3 is in the form of a thermally conductive module block which comprises a plurality of fluid channels, by means of which the fluid can be removed from the reservoir 1 and can also be fed back into the reservoir 1.

On the reservoir side, that is to say inside the volume of the reservoir 1, the connection module 3 is provided with an intake fitting 5 and with a feedback line 6.

On the side which faces away from the reservoir volume, the connection module 3 is provided with a ventilation connection 3a, a return feed flow connection 3b and a feed (supply) feed flow connection 3c. To the return feed flow connection 3b, a return feed flow line 7 of the line system is connected, and to the feed feed flow connection 3c, a feed (supply) feed flow line 8 of the line system is connected. The feed feed flow line 8 is connected to a conveying pump 9 on the suction side, which pump supplies the fluid, via a filter which is not described in greater detail, to a distributor 10, to which a plurality of injection nozzles 11 are connected in turn. The conveying pump 9 is expediently in the form of a conveying pump having a conveying direction which can be reversed.

The fluid not used by the injection nozzles 11 is fed back into the reservoir 1 via the return feed flow line 7. In the return feed flow line 7, a heat exchanger 18 is arranged, by means of which heat can be coupled out of the primary cooling circuit of the internal combustion engine (not shown) into the return volume flow or into the return feed flow line 7.

The return volume flow, which is thus heated for example to 60° C., heats the connection module, and the heat thus generated is introduced into the volume of the reservoir 1 via thermally conductive members 12 on the connection module 3. The thermally conductive members 12 are in the form of ribs protruding into the volume of the reservoir 1.

Furthermore, the heated return volume flow is injected into the reservoir via the feedback line 6. The return volume flow is sprayed by means of at least one throttle or expansion nozzle inside the volume of the reservoir 1. For the sake of simplicity, the throttle or expansion nozzle is referred to in the following as a distribution nozzle 14.

According to the invention, it is assumed that an ice-free zone will firstly appear in the immediate vicinity of the connection module 3. The volume defrosted in this region is removed via the intake fitting 5.

Should a hollow space or a cavity 13 then be formed inside the ice which is present in the reservoir 1, the fluid sprayed by means of the distribution nozzle 14 of the feedback line 6 causes further defrosting of the ice.

According to the invention, the connection module 3 is in the form of a multiway valve and provided in such a way that the return feed flow line 7 and the feed feed flow line 8 can be drained or ventilated. Furthermore, the reservoir 1 can also be drained via the connection module 3 for servicing purposes. The connection module 3 can be in the form of a three/three-way valve or also a four/five-way valve.

The connection module 3 can comprise an additional electric heater (not shown). By means of the electric heater, which is provided as a start-up heater, the thermally conductive member 12 of the connection module, which acts as a heating member, is heated up. In a start-up phase of the motor vehicle, a first small amount of the fluid is thereby defrosted so that the conveying pump 9 can firstly convey a first amount of the fluid to the internal combustion engine and so that a minimum amount of the fluid can be circulated through the system.

FIG. 1a is an enlarged view of the system according to FIG. 1, wherein in FIG. 1a, like components are provided with the same reference signs.

FIG. 1a shows, in outlines, in particular the formation of a cavity 13 inside the frozen fluid which is arranged in the reservoir 1. When, during a start-up phase of the motor vehicle, part of the frozen fluid which is located in the reservoir 1 is defrosted and conveyed out of the reservoir by means of the conveying pump 9 and the feed feed flow line 8, such a cavity 13 is firstly formed, as a result of which no more significant heat transfer takes place from the thermally conductive member 12 into the frozen fluid. To ensure that the frozen fluid also continues to defrost, the fluid heated in the return feed flow line 7 is depressurized and sprayed by means of the distribution nozzles 14 inside the reservoir 1. The warm sprayed fluid condenses on the ice block inside the reservoir and causes the fluid, to further defrost and run off which fluid collects in front of the feed feed flow connection 3c and can thus be conveyed.

To bring about a more uniform distribution of the heated return volume flow inside the reservoir, according to one variant of the invention, provision is made for an impeller 15 to be arranged in front of the distribution nozzle 14, which impeller is rotatably mounted and can be impinged upon by the fluid and which impeller can be driven by means of the liquid issuing from the distribution nozzle 14.

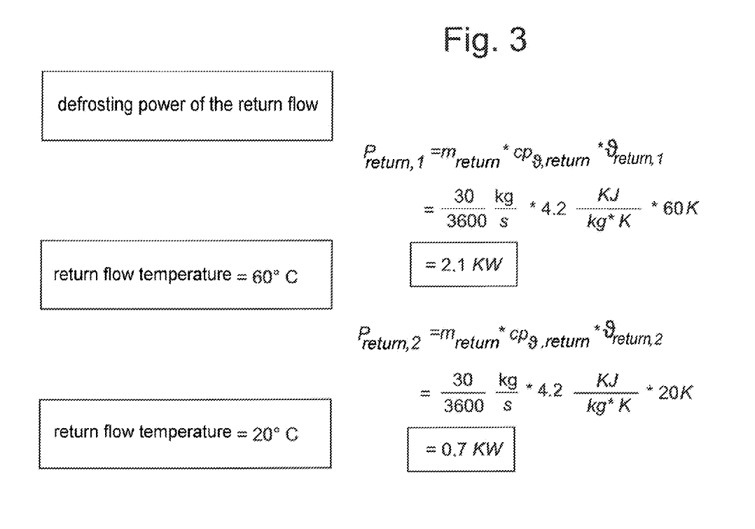

As shown in particular in FIG. 4a, in this variant of the system according to the invention, it is provided that two distribution nozzles 14 are connected to a return flow distributor which is in the form of a Y-shaped distributor.

The impeller 15 comprises two propeller blades which each have a hydraulically effective profile. The distribution nozzles 14 which are arranged symmetrically with respect to the impeller depressurize the fluid in the direction of the impeller 14 and bring about driving of the impeller, which is set into rotation by the dynamics of the fluid. The spray cone respectively issuing from the distribution nozzle 14 is distributed over a relatively large surface area inside the reservoir 1 by the rotation of the impeller 15.

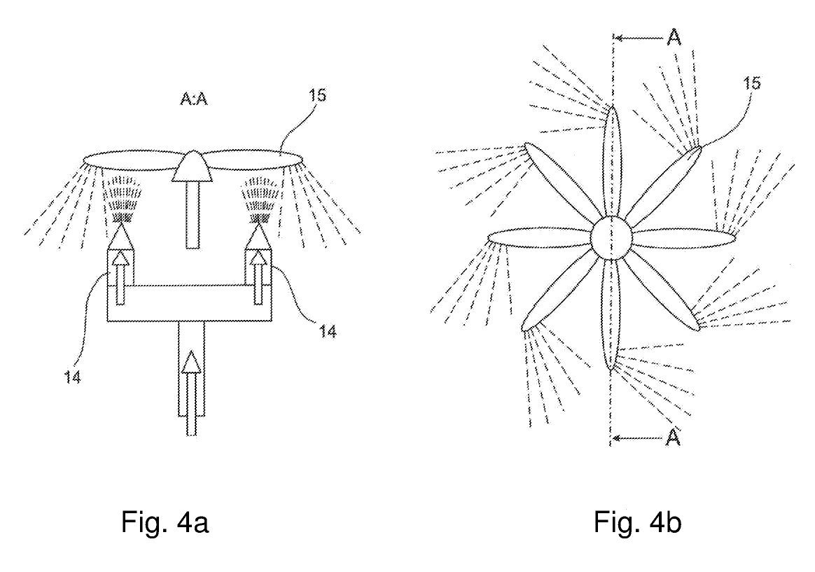

Another variant of the system according to the invention is shown in FIG. 5, which shows a rotatable nozzle assembly 16, on which two distribution nozzles 14 are arranged, which each comprise outlet openings which point in diametrically opposed directions. As a result, in each case opposite impetuses are generated during the depressurization of the fluid, which impetuses introduce a torque into the nozzle assembly 16 and consequently set said assembly into rotation. A uniform distribution of the depressurized, heated fluid is thereby generated over a large surface area in the manner of a sprinkler.

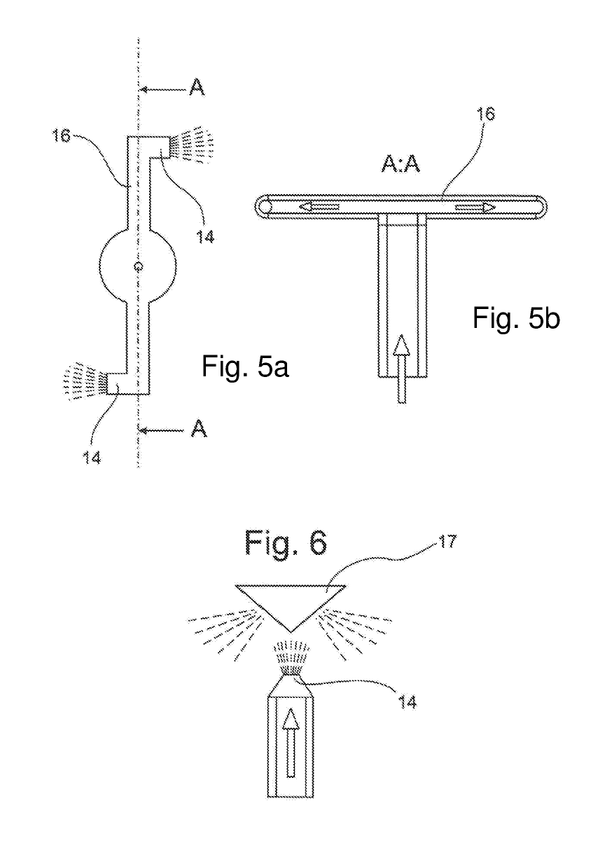

Another variant of the system according to the invention is shown in FIG. 6. Said system comprises a distribution nozzle 14, in front of which an impact body 17 is arranged. The impact body 17 is in the form of a cone/prism, the point of the cone pointing toward the distribution nozzle 14 and being arranged symmetrically with respect to an outlet opening of the distribution nozzle.

In this way, the impact body 17 reflects and duplicates the spray cone of the fluid issuing from the distribution nozzle 14.

In each of the embodiments shown in FIGS. 4 to 6, means for enlarging/distributing the spray cone of the depressurized fluid issuing from one or more distribution nozzles 14 are provided, which are arranged directly in front of the relevant distribution nozzle 14.

### LIST OF REFERENCE NUMERALS

1 reservoir
2 filling pipe
3 connection module
3a ventilation connection
3b return feed flow connection
3c feed feed flow connection
4 opening
5 intake fitting
6 feedback line
7 return feed flow line
8 feed feed flow line
9 conveying pump
10 distributor
11 distribution nozzles
12 thermally conductive member of the connection module
13 cavity inside the frozen fluid
14 distribution nozzles
15 impeller
16 nozzle assembly
17 impact body
18 heat exchanger

What is claimed is:

1-13. (canceled)

17. A system to store an auxiliary liquid and supply the auxiliary liquid to an internal combustion engine of a motor vehicle or to parts of the internal combustion engine of the motor vehicle, comprising:
a reservoir for the auxiliary liquid,
at least one feed pump for the auxiliary liquid, and
at least one line system, which has a feed flow to a load and a return flow from the load into the reservoir, and
a heating device to heat the auxiliary liquid,
wherein the return flow is connected to at least one distribution nozzle inside the reservoir, by which distribution nozzle the auxiliary liquid from the return flow is distributed in the reservoir.

18. The system as claimed in claim 17, wherein the heating device to heat the auxiliary liquid is arranged to heat the return flow.

19. The system as claimed in claim 17, wherein, the heating device to heat the auxiliary liquid comprises an electrical heating device and/or a heat exchanger.

20. The system as claimed in claim 19, wherein the electrical heating device and/or the heat exchanger are arranged in the return flow.

21. The system as claimed in claim 19, wherein the heat exchanger is thermally coupled to a primary cooling circuit of the internal combustion engine.

22. The system as claimed in claim 17, further comprising a connection module which is inserted in an opening of the reservoir, the connection module comprising fluid channels which communicate with the reservoir and which are connected to the line system, and the connection module comprising a module block which is preferably in the form of a thermally conductive member.

23. The system as claimed in claim 21, wherein the connection module comprises at least one thermally conductive member which extends into the volume of the reservoir.

24. The system as claimed in claim 17, further comprising an impeller arranged in front of the distribution nozzle, which impeller is rotatably mounted and arranged to be impinged upon by the auxiliary liquid, and which impeller is arranged to be driven by the auxiliary liquid issuing from the distribution nozzle.

25. The system as claimed in claim 17, further comprising an impact body arranged in front of the distribution nozzle, which impact body brings about a further distribution of the auxiliary liquid.

26. The system as claimed in claim 25, wherein the impact body comprises a cone or a prism.

27. The system as claimed in claim 17, further comprising a rotatably arranged nozzle assembly, which comprises two distribution nozzles which are oriented relative to one another such that the potential energy of the auxiliary liquid issuing from the distribution nozzles is converted into a torque which sets the nozzle assembly into rotation.

28. A method for operating a system to store an auxiliary liquid and supply the auxiliary liquid to an internal combustion engine of a motor vehicle or to parts of the internal combustion engine of the motor vehicle, comprising:
providing a system comprising
a reservoir for the auxiliary liquid,
at least one feed pump for the auxiliary liquid, and
at least one line system, which has a feed flow to a load and a return flow from the load into the reservoir, and
a heating device to heat the auxiliary liquid,
wherein the return flow is connected to at least one distribution nozzle inside the reservoir, by which distribution nozzle the auxiliary liquid from the return flow is distributed in the reservoir.
coupling heat into the auxiliary liquid by the heating device, wherein the return flow of the auxiliary liquid inside the reservoir is depressurized from a first, high pressure to a second, lower pressure, using at least one distribution nozzle.

29. The method as claimed in claim 28, wherein the heat coupled into the auxiliary liquid is extracted from a primary cooling circuit of the internal combustion engine.

30. The method as claimed in claim 28, wherein the return volume flow is heated to a temperature of at most 60° C.
